(19) United States
(12) Patent Application Publication
(10) Pub. No.: US 2013/0232931 A1
(43) Pub. Date: Sep. 12, 2013

(54) INLINE DUCT FILTER

(71) Applicant: Stewart Miller Malcolm, Boulder, CO (US)

(72) Inventor: Stewart Miller Malcolm, Boulder, CO (US)

(21) Appl. No.: 13/791,344

(22) Filed: Mar. 8, 2013

Related U.S. Application Data
(60) Provisional application No. 61/609,215, filed on Mar. 9, 2012.

(51) Int. Cl. B01D 46/00

(52) U.S. Cl. CPC B01D 46/0004
USPC 55/481

(57) ABSTRACT

Inline duct filters are disclosed herein. An embodiment of a filter includes a box with an opening in the box, wherein a door is receivable in the opening. A channel is located in the box and proximate the opening, wherein a filter element is receivable in the opening and the channel. At least two air ports are located in the box, wherein an air path extends between the air ports and through the location for the filter element.

This application claims priority to U.S. provisional patent application 61,609,216 filed on Mar. 9, 2012 for INLINE DUCT FILTER, which is incorporated by reference for all that is disclosed.

### BACKGROUND

Duct filters remove particles and odors from air passing through ducts. Filter elements located within the duct filters are difficult to replace. For example, some duct filters have filter elements located therein that are difficult to access, which makes changing the elements very difficult.

### SUMMARY

Inline filters are disclosed herein. An embodiment of an inline duct filter includes a box with an opening in the box, wherein a door is receivable in the opening. A channel is located in the box and proximate the opening, wherein a filter element is receivable in the opening and the channel. At least two air ports are located in the box, wherein an air path extends between the air ports and through the location for the filter element.

### BRIEF DESCRIPTION OF THE DRAWINGS

FIG. 1 is a lower isometric view of an embodiment of an inline duct filter, wherein an access door is removed.

FIG. 2 is an enlarged view of the inline duct filter of FIG. 1.

FIG. 3 is a side isometric view of an embodiment of an inline duct filter.

FIG. 4 is a bottom plan view of an inline duct filter with an access door in place.

FIG. 5 is a cut away perspective view of an embodiment of an inline duct filter.

FIG. 6 is a side elevation view of the fitter of FIG. 3.

FIG. 7 is a top side elevation view of an embodiment of the inline duct filter of FIG. 1.

### DETAILED DESCRIPTION

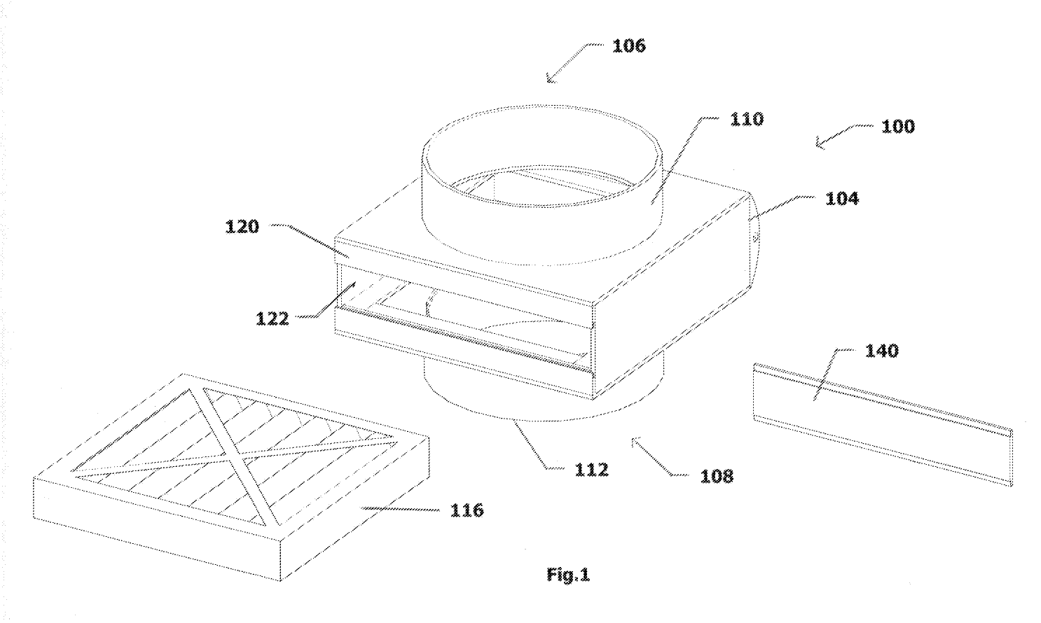

Inline duct filters are disclosed herein. An embodiment of an inline duct filter 100 (sometimes referred to simply as a filter) is shown in FIG. 1, which is a lower isometric view of the filter 100. The filter 100 includes a box 104, an input port 106 (sometimes referred to as a first port), and an output port 108 (sometimes referred to as a second port). The input port 106 is sometimes referred to being on a first side of the box 104 and the output port 108 is sometimes referred to being on a second side of the box 104. The input port 106 and the output port 108 may be interchanged depending on the direction of airflow through the box 104. The ports 106, 108 have openings 110, 112 that enable air to flow through the ports 106, 108.

The ports 106, 108 enable the filter 100 to be connected to conventional duct work. The ports 106, 108 are shown as being circular, but they may be any shape and any size. For example, the ports 106, 108 may be rectangular or square in order to fit into rectangular or square duct work. The box 104 contains an air filter element 116 that is readily replaceable. In some embodiment, the air filter element 116 may be grasped by a user by opening a door on the box 104. An air path extends between the openings 110, 112, which is through the box 104 and the element 116. As described in greater detail below, the element 116 may be sealed against the box 104 so that substantially all the air passing through the box 104 passes through the element 116.

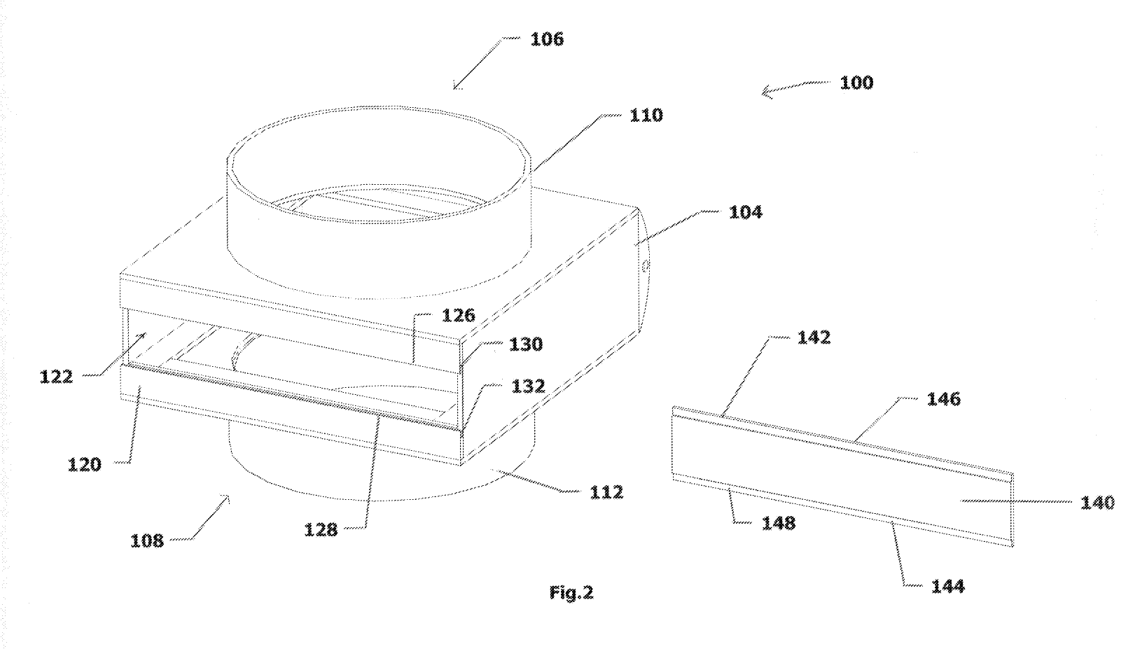

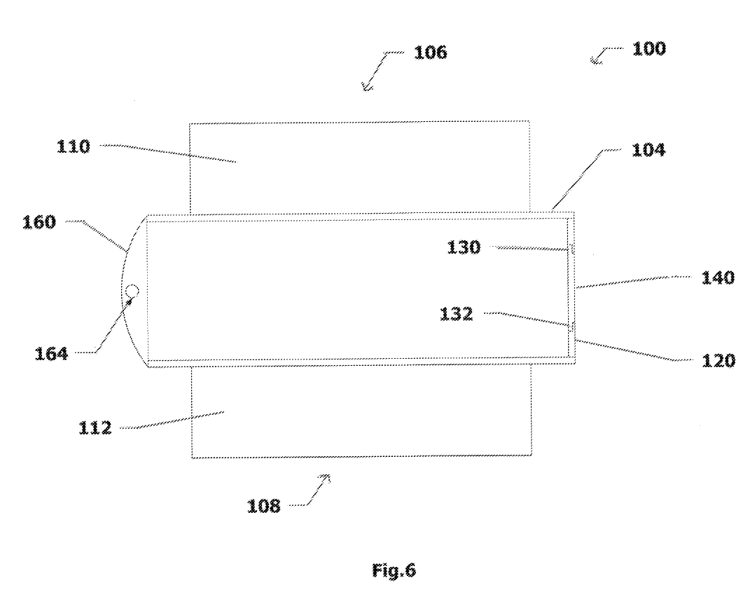

FIG. 2 shows an enlarged view of the filter 100. The box 104 has a side 120 that is sometimes referred to as a bottom side 120. However, the side 120 may be oriented in any direction depending on the placement and/or orientation of the filter 100. The side 120 has an opening 122 that is sized to receive the element 116, FIG. 1. In the embodiment of FIG. 2, the opening 122 is bounded by a first side 126 and a second side 128. The first side 126 has a recessed portion 130 and the second side 128 has a recessed portion 132. The recessed portions 130, 132 may be substantially parallel to each other. The recessed portions 130, 132 are also shown in FIG. 6, which is a side elevation view of the filter 100.

A door 140 is able to seal or otherwise cover the opening 122. In the embodiments described herein, the door 140 has a first edge 142 and a second edge 144. The first edge 142 has a recessed portion 146 and the second edge 144 has a recessed portion 148. The door 140 is slidable into the opening 120 wherein the recessed portions 146, 148 on the door 140 engage the recessed portions 130, 122 in the side 120 of the box 104. The door 140 slides from the side 120 to expose the opening 122. In such a state, the element 116 may be readily changed. For example, at least a portion of the element 116 may be located proximate the opening 122 so that it may be readily grasped. When the element is in the box 140, the door 140 is slid into the side 120 so as to cover the opening 122. The use of the door 140 prevents air from leaking through the opening 122, although, an insignificant amount of it may leak between the door 140 and the sides 126, 128. Therefore, the door 140 prevents air passing between the ports 106, 108 from escaping out of the box 104. The embodiments described herein described the door 140 that is slidable in the opening 120. Other embodiments of the door may include hinge-type doors and other configurations. On some embodiments, the door 140 contacts at least a portion of the filter element 116.

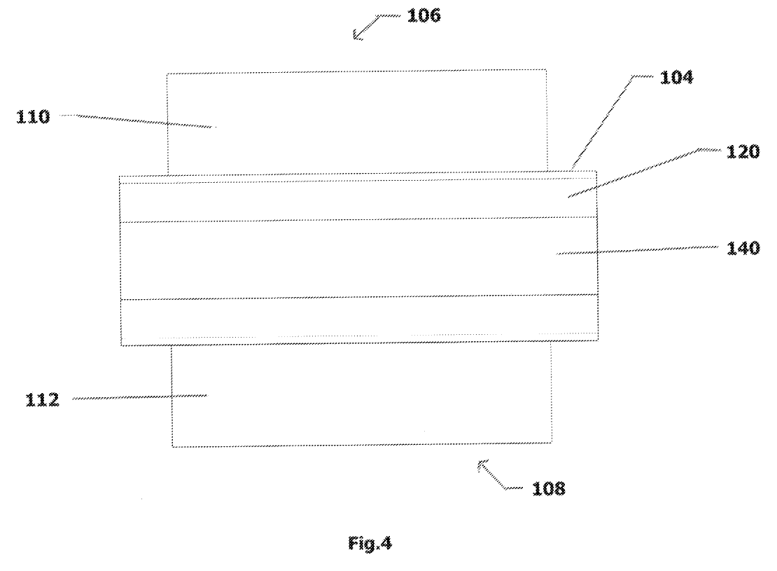

Further reference is made to FIG. 4, which is a plan view of the side 120 of the box 104. In the view of FIGS. 4 and 6, the door 140 is in place in the side 120 of the box 104. When the door 140 is in place, a continuous, smooth, and flat surface may be created between the door 140 and the side 120. The smooth surface created by the door 140 prevents protrusions from extending from the side 120.

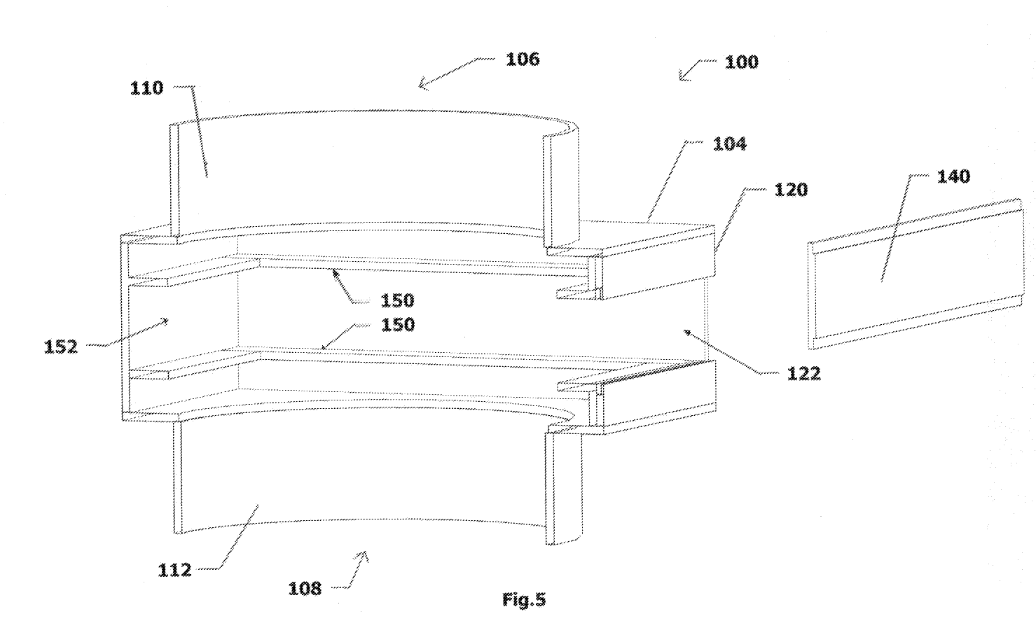

Reference is made to FIG. 5, which is a cut away view of the filter 100. The interior of the box 104 has a plurality of rails 150 that form a channel 152. The channel 152 is sized to receive the element 116 FIG. 1. The width of the channel 152 may be slightly greater than the width of the element 116, which enables the element to slide through the opening 122 and into the channel 152, in other embodiments, the width of the channel 152 may be slightly smaller than the width of the element 116, which causes the element to have a tight fit within the channel 152.

The channel 152 along with the rails 150 serve to prevent air from passing around the element 116 when the element 116 is located in the box 104. In some embodiments, the edges of the element 116 may be pliable and the width of the channel 152 may be slightly less then the width of the element 116. In this embodiment, the element may fit snug within the channel 152. The snug fit seals the element 116 to the rails 150 and prevents air from passing around the element 116. Rather, the air flow is through the element 116. In some embodiments, the rails 150 may be pliable so as to form a seal with the element 116. In other embodiments, the rails 150 may have a gasket (not shown) or the like formed thereon that seals the element 116 to the rails 150. In these embodiments, the element 116 is sealed within the box 104 in order to force all the air flowing through the box 104 to pass through the element 116. The box 104 has been shown with the rails 150. It is noted that the rails are a securing mechanism for the element 116 and other securing mechanism may be used. In some embodiments, the sides of the box 116 serve to retain the element 116 and the rails 150 are not required and their function is served by the sides of the box 104.

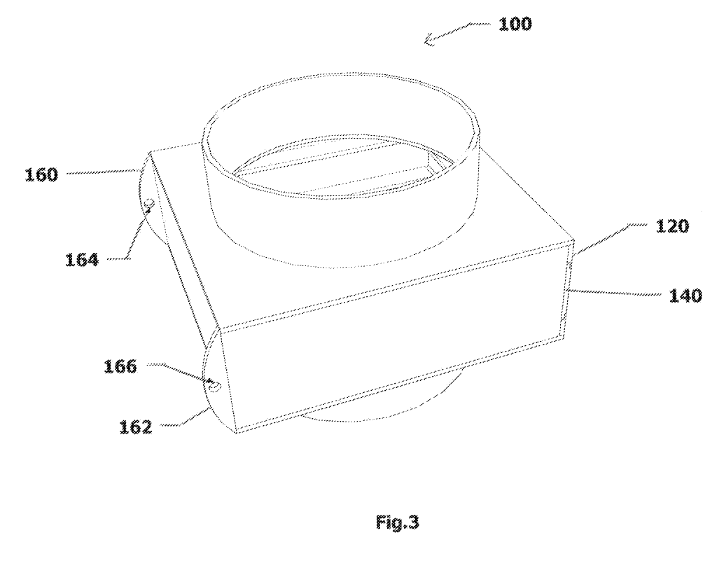

An embodiment of the box 104 with attachment mechanisms 160, 162 is shown in FIGS. 3 and 6. The attachment mechanisms 160, 162 are located on opposite sides of the box 104 and serve to secure the filter 100 in a fixed location. The attachment mechanisms 160, 162 may each have a hole 164, 166 formed therein. The holes may receive screws, nails, or other devices that serve to secure the fitter 100 to a structure, such as a floor joist. In the embodiment of FIGS. 3 and 6, the attachment mechanisms 160, 162 extend from the side of the box 104 opposite the door 140. The attachment mechanism 160, 162 may otherwise interfere with the operation of the door 140. In some embodiments, the attachment mechanisms 100, 162 extend proximate the door 140 and have holes to enable the door 140 to slide therethrough.

In use, the door 140 is removed from the side 120 and the element 116 is placed through the opening 120 and into the channel 152. The door 140 is then slid back into place in the side 120. The air flow between the ports 106, 108 then passes through the element 116. Ducts (not shown) are attached to the ports 106, 108 in a conventional manner. For example, clamps or the like may attach the ducts to the ports 110, 112. Air is then forced through the ducts, which passes into the box 104 by way of an opening 110, 112 and is filtered by the element 118. The filtered air then exits the other opening 110, 112. In some embodiments, the filter 100 may be affixed to a structure not shown) by way of the attachment mechanisms 180, 182. When the filter needs to be changed, the door 140 is slid open and the element 118 is removed from the box 104. A new element is readily inserted into the box 104 and the box is sealed by replacing the door 140.

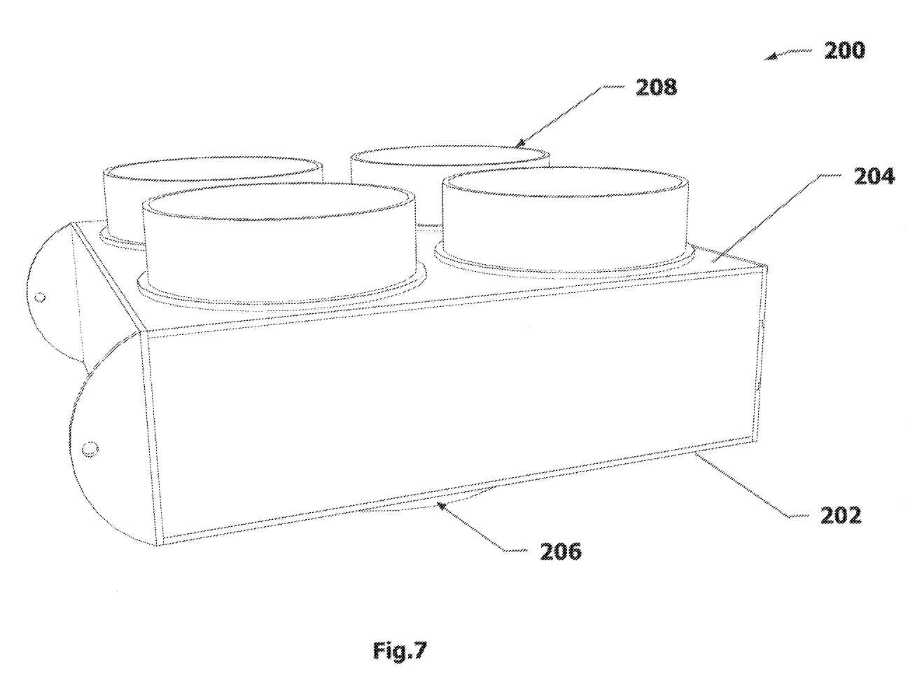

Having described the filter 100 and its operation, other embodiments of the filter 100 will now be described. Reference is made to FIG. 7, which shows an embodiment of an inline duct filter 200 that functions similar to a manifold. The filter 200 has a first side 202 and an opposite second side 204. The first side 202 may have a single first port 206 that is identical or substantially similar to the input port 106 on the filter 100. The second side 204 has a plurality of second ports 208. In the embodiment of FIG. 7, the filter 200 has four second ports 208. The filter 200 enables a single air supply to be connected to the first port 208 and be divided to several different locations by way of the plurality of the second ports 208. More specifically, the second ports 208 may be connected to ducts that divert air to different locations. In some embodiments, the second ports 208 have air valves (not shown) or the like that regulate the amount of air flow in each of the second ports 208. Therefore, air flow to a plurality of different locations may be regulated from the single filter 200.

The inline duct filters 100, 200 described above may be used in indoor growing facilities, such as green houses. In such facilities, filtered air improves growing in that it prevents dust from building up on the plants. The growing facility may have a blower or the like that blows air into the facility by way of a duct that passes through a wall of the facility. The duct may be attached to the first port 106, 206, which may be located within or outside the facility the facility. Another duct may be connected to the second port 108, 208. The air from the second port 208 may be delivered to specific areas within the growing facility. In the embodiment of the duct filter 200 of FIG. 7, air may be directed to a plurality of locations within the growing facility by use of the plurality of second ports 208.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed:

1. An inline duct filter comprising:
a box;
an opening in the box;
a door that is attachable to the box, wherein the door has an open state and a closed state and wherein a filter element is receivable through the opening when the door is in the open state;
a channel in the box, wherein the filter element is receivable in the channel;
at least one first port that is connectable to at least one duct;
at least one second port that is connectable to at least one duct; and
an air path extending between the first port and the second port and through the filter element.

2. The filter of claim 1 comprising a single first port.

3. The filter of claim 1, wherein the channel forms a seal with the filter element.

4. The filter of claim 3 and further comprising at least one gasket in the channel, wherein the gasket is contactable with the filter element.

5. The filter of claim 1, wherein the filter is pliable and wherein the width of the channel is less than the width of the filter.

6. The filter of claim 1 wherein the door is slidable relative to the box.

7. The filter of claim 1, wherein the box comprises recessed portions, wherein the door comprises recessed portions, and wherein the recessed portions of the box couple with the recessed portions of the door enabling the door to slide relative to the box.

8. The filter of claim 1 and further comprising a hinge connected between the door and the box, wherein the door is pivotally connected to the box by way of the hinge.

9. The filter of claim 1, wherein the box comprises a surface, and wherein a plurality of second ports extend from the surface.

10. The filter of claim 1, wherein at least a portion of the filter element is located proximate the door.

11. The filter of claim 1, wherein at least a portion of the filter element is contactable with the door.

12. An inline duct filter comprising:
a box having a first side and a second side;
an opening in the box;
a door that is attachable to the box, wherein the door has an open state and a closed state and wherein a filter element is receivable through the opening when the door is in the open state;
at least one first port located on the first side of the box that is connectable to at least one duct;
a plurality of second ports located on the second side of the box that are connectable to at least one duct; and
an air path extending between the first port and the second port and through the filter element

13. The filter of claim 12 and further comprising an air valve on at least one of the plurality of second ports.

14. The filter of claim 12 wherein the door is slidable relative to the box.

15. The filter of claim 12, wherein the box comprises recessed portions, wherein the door comprises recessed portions, and wherein the recessed portions of the box couple with the recessed portions of the door enabling the door to slide relative to the box.

16. The filter of claim 12 and further a channel located in the box, wherein the filter is receivable in the channel.

17. The filter of claim 12, wherein at least a portion of the filter element is located proximate the door.

18. The filter of claim 12, wherein at least a portion of the filter element is contactable with the door.

19. A growing facility comprising:
a wall separating the interior and exterior of the facility:
a duct passing through the wall;
a filter located in the duct, the filter comprising:
a box:
an opening in the box;
a door that is attachable to the box, wherein the door has an open state and a closed state and wherein a filter element is receivable through the opening when the door is in the open state;
a channel in the box, wherein the filter element is receivable in the channel;
at least one first port that is connectable to the duct;
at least one second port that is connectable to the duct, wherein the filter is located in line with the duct; and
an air path extending between the first port and the second port and through the filter element.

20. The facility of claim 19, wherein the box comprises a side and wherein a plurality of second ports extend from the side.
